(19) United States
(12) Patent Application Publication
(10) Pub. No.: US 2002/0196435 A1
(43) Pub. Date: Dec. 26, 2002

(54) Apparatus and methods for separating agglutinants and disperse particles

(76) Inventors: David Samuel Cohen, Alphretta, GA (US); Yih Far Chen, Irvine, CA (US); Lynn Kim, Chino Hills, CA (US); Chih-Hsin Shih, Aliso Viejo, CA (US)

Correspondence Address: HALE AND DORR, LLP, 60 STATE STREET, BOSTON, MA, 02109

(21) Appl. No.: 09/989,684

(22) Filed: Nov. 20, 2001

Related U.S. Application Data
(60) Provisional application No. 60/252,725, filed on Nov. 22, 2000.

(51) Int. Cl. G01N 1/10

(52) U.S. Cl. 356/246

(57) ABSTRACT

Rotating apparatus has a separation zone structure having solid components spaced apart to form gaps. The gaps are large enough to allow disperse particles to change position relative to the center of rotation by passing through the separation zone structure. The gaps are too small to allow particle agglutinants to pass through the separation zone structure.

### CROSS-REFERENCE TO RELATED APPLICATIONS

This application claims the benefit of U.S. Provisional Application No. 60/252,725, entitled OPTICAL BIO-DISC INCLUDING MICROFLUIDIC CIRCUIT FOR SEPARATION AND QUANTITATION OF AGGLUTINATED

MICROPARTICLES OR CELLS AND METHODS RELATING THERETO, filed on November 22, 2000, which is incorporated by reference.

### BACKROUND

This invention relates to separating agglutinants and disperse particles.

Visual detection of agglutinated particles (i.e., clumps of particles called “agglutinants”) has been performed as follows. A specimen is deposited on a card of a contrasting color and is washed in a reagent. A visual check of the card is performed to determine whether clumping has formed.

A blood typing technique has been used in which a specimen tube has a porous resin disposed therein that divides the tube into an upper section above the resin and a lower section below the resin. When a specimen containing blood is added to the upper section, the tube is spun with the lower section positioned outward and the upper section positioned inward, which creates centrifugal force urging the specimen toward the lower end. The porous resin allows disperse particles of the specimen to pass through to the lower section but causes agglutinated particles of the specimen to remain in the upper section. An automated device can determine the presence of particles in the lower section, which can help determine a blood type for the specimen.

Related techniques used in blood group serology are described in Laboratory Medicine Vol. 25, No. 2 Feb. 1994, pp. 81-85.

### SUMMARY OF THE INVENTION

In an aspect of the invention, an optical disc or rotating apparatus has a separation zone structure having solid components spaced apart to form gaps. The gaps are large enough to allow disperse particles to change position relative to the center of rotation by passing through the separation zone structure. The gaps are too small to allow particle agglutinants to pass through the separation zone structure.

Pursuant to another aspect of the invention, an optical disc has a microfluidic circuit that is responsive to centrifugal force resulting from rotation of the disc. The circuit includes an entry chamber for containing a specimen having disperse particles and particle agglutinants and a separation zone structure disposed downstream of the entry chamber. The specimen is urged toward the separation zone structure by the centrifugal force. The separation zone structure has gaps that are large enough to allow disperse particles to escape the entry chamber and that are small enough to retain particle agglutinants in the entry chamber.

In accordance with a further aspect of the invention, the optical disc is used as follows. A biological sample material is dispensed into the entry chamber. An assay reagent including particles bound with at least one type of bioactive agent is dispensed into the entry chamber. The biological sample material is mixed with the assay reagent. The biological sample material is allowed to react with the assay reagent to thereby facilitate formation of an agglutinant. The optical disc is rotated so that non-agglutinated particles escape from the entry chamber through the separation zone structure. Where the agglutinated particles remain, the disc is made to allow an interrogating light beam to be reflected from or transmitted past the particles to allow detection, imaging, and/or counting of the particles.

Implementations of the invention may provide one or more of the following advantages. An assay can be performed on a specimen quickly and inexpensively under controlled conditions. Results of the assay can be determined automatically and data representing the results can be gathered, stored, and distributed electronically and automatically. Inexpensive equipment using existing technology can provide rapid and automatic separation of agglutinated material from disperse material.

Other advantages and features will become apparent from the following description, including the drawings.

### BRIEF DESCRIPTION OF THE DRAWING

FIG. 1A is an exploded view of a reflective bio-disc.

FIG. 1B is a top view of the bio-disc of FIG. 1A.

FIG. 1C is a perspective view of the bio-disc of FIGS. 1A-1B.

FIG. 2A is an exploded view of a transmissive bio-disc.

FIG. 2B is a top view of the bio-disc of FIG. 2A.

FIG. 2C is a perspective view of the bio-disc of FIGS. 2A-2B.

FIG. 3 is a block diagram of an optical reading system.

FIG. 4 is a perspective view of an embodiment of a bio-disc and an optical reading system.

FIG. 5 is a plan view of a bio-disc having one or more embodiments of microfluidic circuits.

FIG. 6 is a plan view of a bio-disc having one or more embodiments of microfluidic circuits and having optical reading tracks.

FIG. 7 is a cross sectional side view of an example implementation of a microfluidic circuit of the present invention as illustrated by example in conjunction with a reverse wobble optical bio-disc, the view taken along a radius of the disc.

FIG. 8 is a plan view of a bio-disc having one or more embodiments of microfluidic circuits.

FIG. 9 is a plan view of a bio-disc having one or more embodiments of microfluidic circuits and having optical reading tracks.

FIG. 10 is a plan view of a bio-disc having one or more embodiments of microfluidic circuits.

FIG. 11 is a plan view of a bio-disc having one or more embodiments of microfluidic circuits.

FIG. 12 is a plan view of a bio-disc having one or more embodiments of microfluidic circuits.

FIG. 13 is a plan view of a bio-disc having one or more embodiments of microfluidic circuits.

FIG. 14 is a plan view of a portion of a bio-disc having one or more embodiments of microfluidic circuits.

### DETAILED DESCRIPTION

An optical bio-disc for use with embodiments of the present invention may have any suitable shape, diameter, or thickness, but preferably is implemented on a round disc with a diameter and a thickness similar to those of a compact disc (CD), a recordable CD (CD-R), CD-RW, a digital versatile disc (DVD), DVD-R, DVD-RW, or other standard optical disc format. The disc may include encoded information, preferably in a known format, for performing, controlling, and post-processing a test or assay, such as information for controlling the rotation rate of the disc, timing for rotation, stopping and starting, delay periods, multiple rotation steps, locations of samples, position of the light source, and power of the light source. Such encoded information is referred to generally as operational information.

The disc may be reflective, transmissive, or some combination of reflective and transmissive. In the case of a reflective disc, an incident light beam is focused onto a reflective surface of the disc, reflected, and returned through optical elements to a detector on the same side of the disc as the light source. In a transmissive disc, light passes through the disc (or portions thereof) to a detector on the other side of the disc from the light source. In a transmissive portion of a disc, some light may also be reflected and detected as reflected light. The light may include any type of electromagnetic radiation, such as visible light, infrared light, or ultraviolet light.

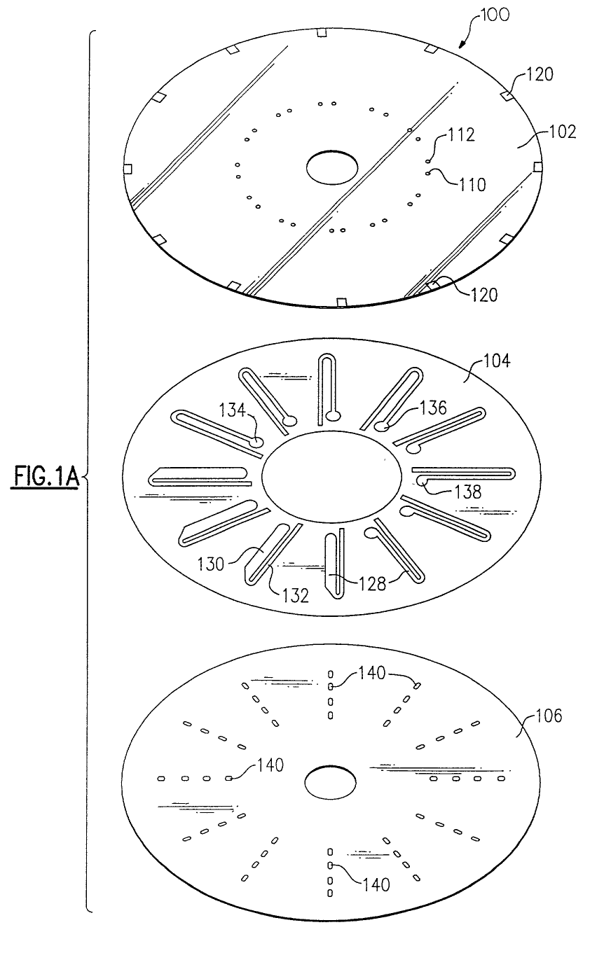

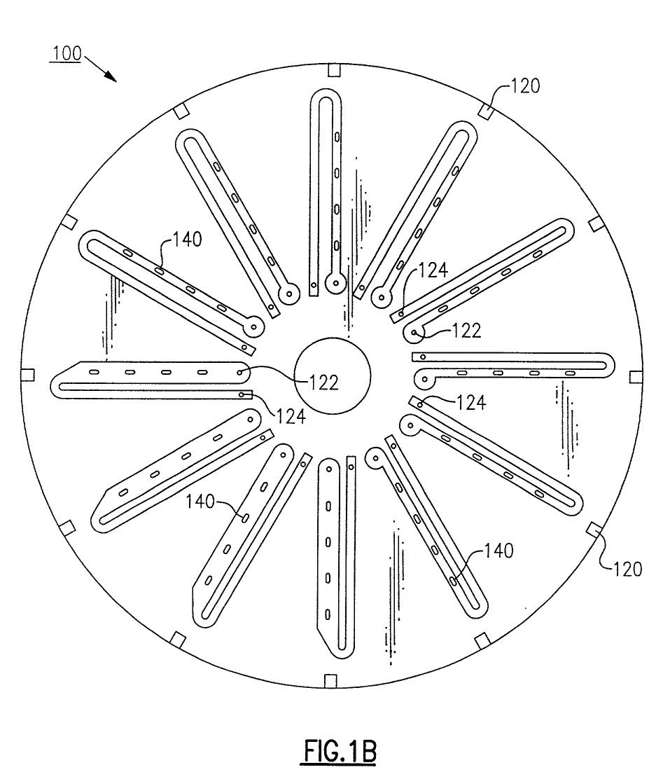

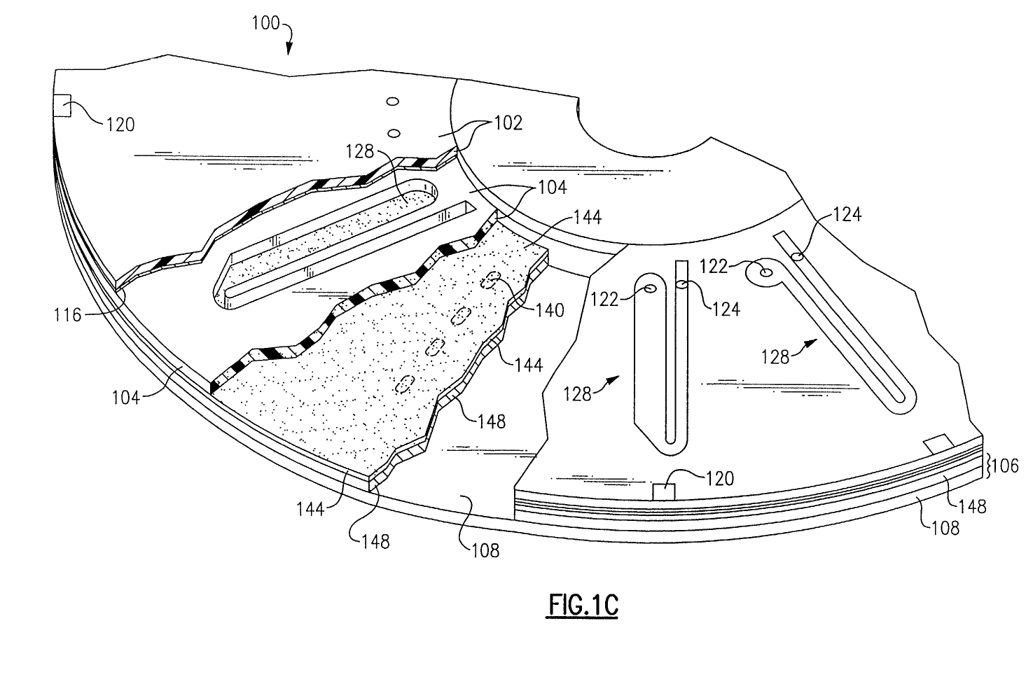

Referring to FIGS. 1A, 1B, and 1C, a reflective disc 100 is shown with a cap 102, a channel layer 104, and a substrate 106. Cap 102 has inlet ports 110 for receiving samples and vent ports 112. Cap 102 may be formed primarily from a material such as polycarbonate, and may be coated with a reflective layer 116 on the bottom thereof. Reflective layer 116 is preferably made from a metal, such as aluminum or gold.

Channel layer 104 defines fluidic circuits 128 by having desired shapes from channel layer 104. Each fluidic circuit 128 preferably has a flow channel 130 and a return vent channel 132, and some have a mixing chamber 134. A mixing chamber 136 can be symmetrically formed relative to the flow channel 130, while an off-set mixing chamber 138 is formed to one side of the flow channel 130. Fluidic circuits 128 can include other channels and chambers, such as preparatory regions or a waste region, as shown, for example, in U.S. Pat. No. 6,030,581, which is incorporated herein by reference. Channel layer 104 can include adhesives for bonding substrate to cap.

Substrate 106 has a non-conductive (e.g., polycarbonate) layer 108, and has target zones 140 formed as openings in a reflective layer 148 deposited on the top of layer 108. Target zones 140 may be formed by removing portions of reflective layer 148 in any desired shape, or by masking target zone areas before applying reflective layer 148. Reflective layer 148 is preferably formed from a metal, such as aluminum or gold, and can be configured with the rest of the substrate to encode operational information that is read with incident light, such as through a wobble groove or through an arrangement of pits. Light incident from under substrate 106 thus is reflected by layer 148, except at target zones 140, where it is reflected by layer 116. Target zones may have imaged features without capture, while a capture zone generally refers to a location where an antibody or other anti-ligand is located.

Referring particularly to FIG. 1C, optical disc 100 is cut away to illustrate a partial cross-sectional view. An active capture layer 144 is formed over reflective layer 148. Capture layer 144 may generally be formed from nitrocellulose, polystyrene, polycarbonate, gold, activated glass, modified glass, or a modified polystyrene, for example, polystyrene-co-maleic anhydride. Channel layer 104 is over capture layer 144. Polystyrene is generally preferred for a WBC capture zone.

Trigger marks 120 are preferably included on the surface of a reflective layer 148, and may include a clear window in all three layers of the disc, an opaque area, or a reflective or semi-reflective area encoded with information. These are discussed below.

In operation, samples are introduced through inlet ports 110 of cap 102. When rotated, the sample moves outwardly from inlet port 110 along capture layer 144. Through one of a number of biological or chemical reactions or processes, detectable features may be present in the target zones. These features are referred to as investigational features. Examples of such processes are shown in the incorporated U.S. Pat. No. 6,030,581.

The investigational features captured by the capture layer may be designed to be located in the focal plane coplanar with reflective layer 148, where an incident beam is typically focused in conventional readers; alternatively, the investigational features may be captured in a plane spaced from the focal plane. The former configuration is referred to as a “proximal” type disc, and the latter a “distal” type disc.

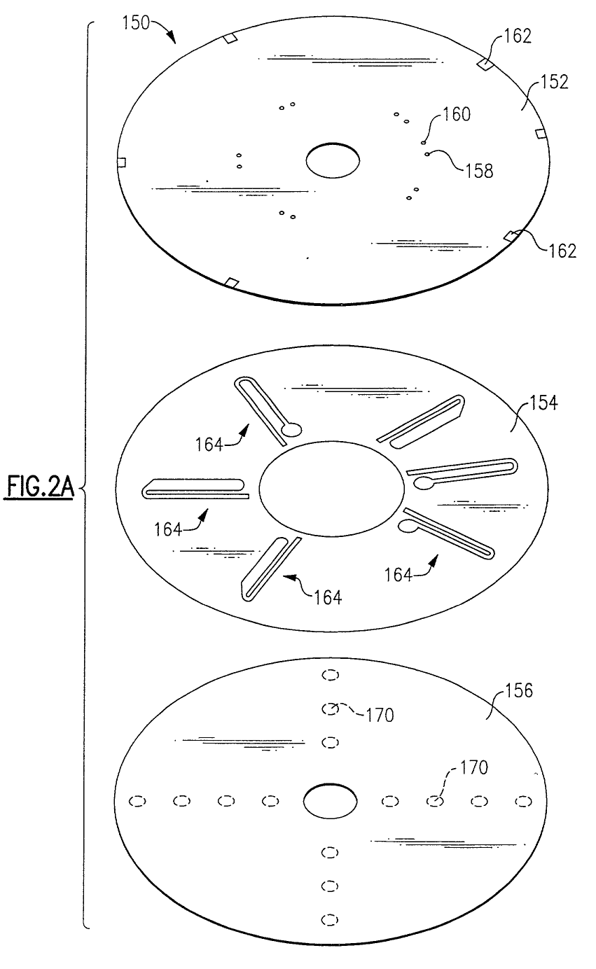

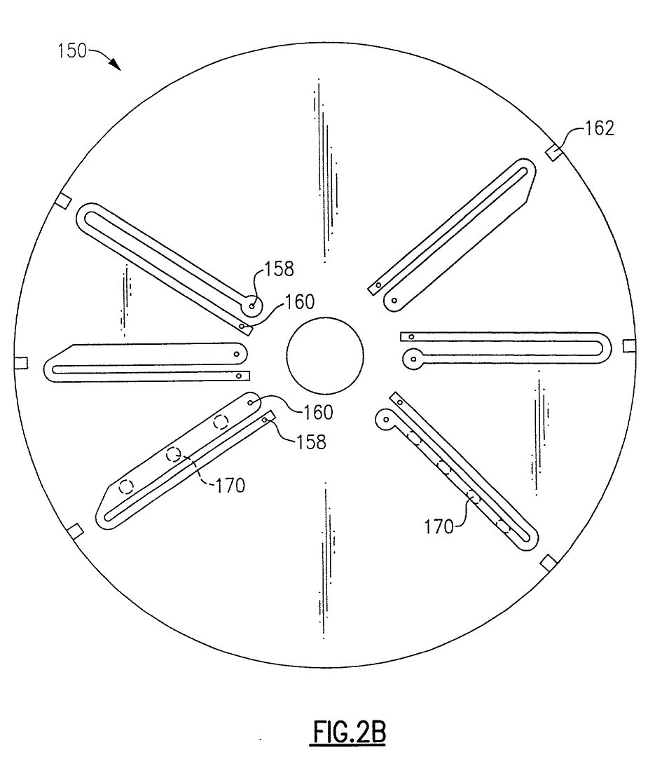

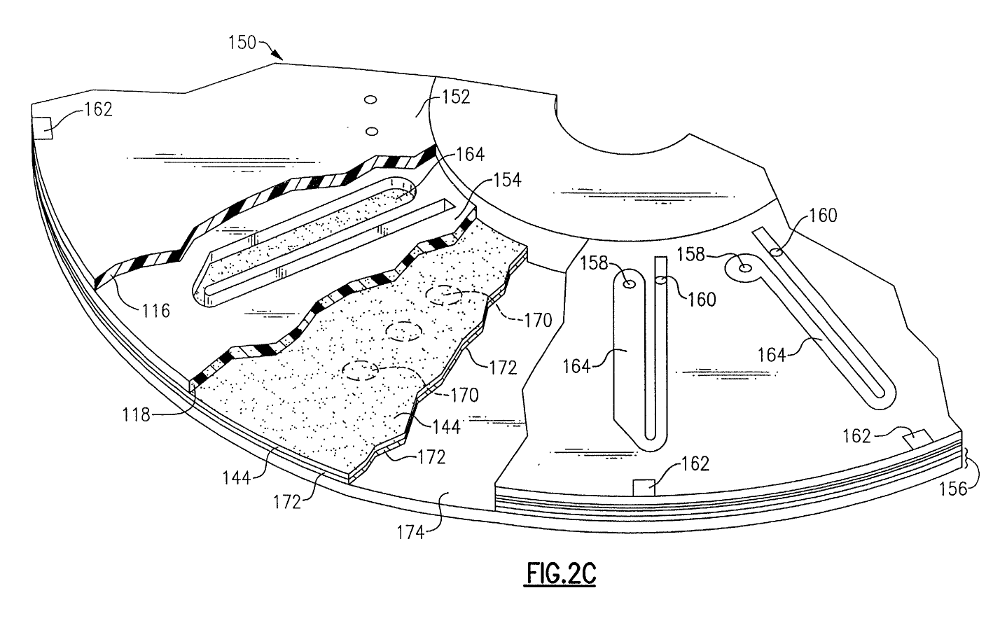

Referring to FIGS. 2A, 2B, and 2C, a transmissive or semi-reflective optical disc 150 has a cap 152, a channel layer 154, and a substrate 156. Cap 152 includes inlet ports 158 and vent ports 160 and is preferably formed mainly from polycarbonate. Trigger marks 162 similar to those for disc 100 may be included. Channel layer 154 has fluidic circuits 164, which can have structure and use similar to those described in conjunction with FIGS. 1A, 1B, and 1C.

Substrate 156 may include target zones 170, and preferably includes polycarbonate layer 174. Substrate 156 may, but need not, have a thin semi-reflective reflective layer 172 deposited on top of layer 174. Semi-reflective layer 172 is preferably significantly thinner than reflective layer 148 on substrate 106 of reflective disc 100 (FIGS. 1A-1C). Semi-reflective layer 172 is preferably formed form a metal, such as aluminum or gold, but is sufficiently thin to allow a portion of an incident light beam to penetrate and pass through layer 172, while some of the incident light is reflected back. A gold film layer, for example, is 95% reflective at a thickness greater than about 700 Å, while the transmission of light through the gold film is about 50% transmissive at approximately 100 Å.

FIG. 2C is a cut-away perspective view of disc 150. The semi-reflective nature of layer 172 makes its entire surface available for target zones, including virtual zones defined by trigger marks or specially encoded data patterns on the disc. Target zones 170 may also be formed by marking the designated area in the indicated shape or alternatively in any desired shape. Markings to indicate target zone 170 may be made on semi-reflective layer 172 or on a bottom portion of substrate 156 (under the disc). Target zones 170 may be created by silk screening ink onto semi-reflective layer 172.

An active capture layer 180 is applied over semi-reflective layer 172. Capture layer 180 may be formed from the same materials as described above in conjunction with layer 144 (FIG. 1C) and serves substantially the same purpose when a sample is provided through an opening in disc 150 and the disc is rotated. In transmissive disc 150, there is no reflective layer comparable to reflective layer 116 in reflective disc 100 (FIG. 1C).

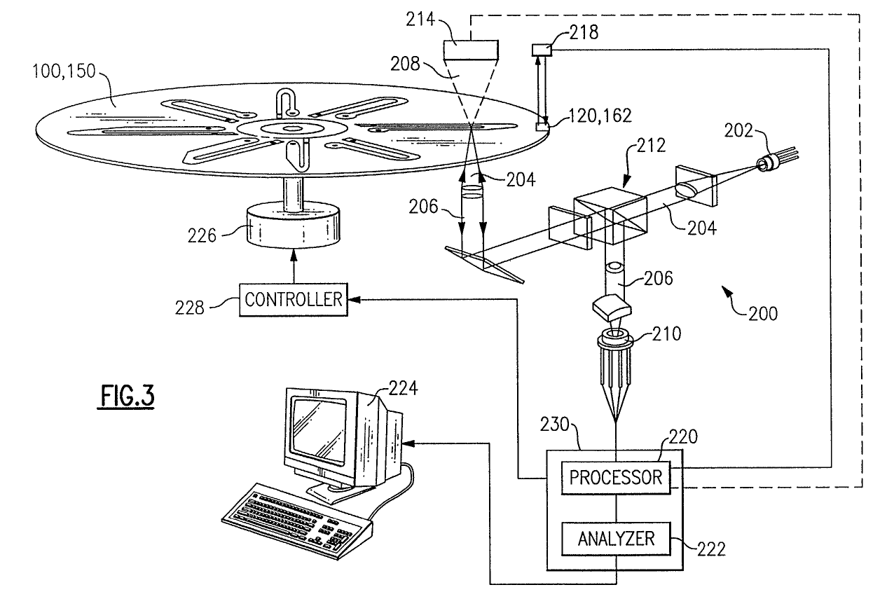

FIG. 3 shows an optical disc reader system 200. This system may be a conventional reader for CD, CD-R, DVD, or other known comparable format, a modified version of such a drive, or a completely distinct dedicated device. The basic components are a motor for rotating the disc, a light system for providing light, and a detection system for detecting light.

A light source 202 provides light to optical components 212 to produce an incident light beam 204, a return beam 206, and a transmitted beam 208. In the case of reflective disc 100, return beam 206 is reflected from either reflective surface 148 or 116. Return beam 206 is provided back to optical components 212, and then to a bottom detector 210. For transmissive disc 150, a transmitted beam 208 is detected by a top detector 214. Optical components 212 can include a lens, a beam splitter, and a quarter wave plate that changes the polarization of the light beam so that the beam splitter directs a reflected beam through the lens to focus the reflected beam onto the detector. An astigmatic element, such as a cylindrical lens, may be provided between the beam splitter and detector to introduce astigmatism in the reflected light beam.

Data from detector 210 and/or detector 214 is provided to a computer 230 including a processor 220 and an analyzer 222. An image or output results can then be provided to a monitor 224. Computer 230 can represent a desktop computer, programmable logic, or some other processing device, and also can include a connection (such as over the Internet) to other processing and/or storage devices. A drive motor 226 and a controller 228 are provided for controlling the rotation and direction of disc 100 or 150. Controller 228 and the computer with processor 220 can be in communication or can be the same computer. Methods and systems for reading such a disc are also shown in Gordon, U.S. Pat. No. 5,892,577, which is incorporated herein by reference.

A hardware trigger sensor 218 may be used with either a reflective or transmissive disc. Triggering sensor 218 provides a signal to computer 230 (or to some other electronics) to allow for the collection of data by processor 220 only when incident beam 204 is on a target zone. Alternatively, software read from a disc can be used to control data collection by processor 220 independent of any physical marks on the disc.

The substrate layer may be impressed with a spiral track that starts at an innermost readable portion of the disc and then spirals out to an outermost readable portion of the disc. In a non-recordable CD, this track is made up of a series of embossed pits with varying length, each typically having a depth of approximately one-quarter the wavelength of the light that is used to read the disc. The varying lengths and spacing between the pits encode the operational data. The spiral groove of a recordable CD-like disc has a detectable dye rather than pits. This is where the operation information, such as the rotation rate, is recorded. Depending on the test, assay, or investigational protocol, the rotation rate may be variable with intervening or consecutive periods of acceleration, constant speed, and deceleration. These periods may be closely controlled both as to speed and time of rotation to provide, for example, mixing, agitation, or separation of fluids and suspensions with agents, reagents, antibodies, or other materials.

Numerous designs and configurations of an optical pickup and associated electronics may be used in the context of the embodiments of the present invention. Further details and alternative designs for compact discs and readers are described in Compact Disc Technology, by Nakajima and Ogawa, IOS Press, Inc. (1992); The Compact Disc Handbook, Digital Audio and Compact Disc Technology, by Baert et al. (eds.), Books Britain (1995); and CD-Rom Professional's CD-Recordable Handbook: The Complete Guide to Practical Desktop CD, Starrett et al. (eds.), ISBN: 0910965188 ( 1996); all of which are incorporated herein in their entirety by reference.

The disc drive assembly is thus employed to rotate the disc, read and process any encoded operational information stored on the disc, analyze the liquid, chemical, biological, or biochemical investigational features in an assay region of the disc, to write information to the disc either before or after the material in the assay zone is analyzed by the read beam of the drive or deliver the information via various possible interfaces, such as Ethernet to a user, database, or anywhere the information could be utilized.

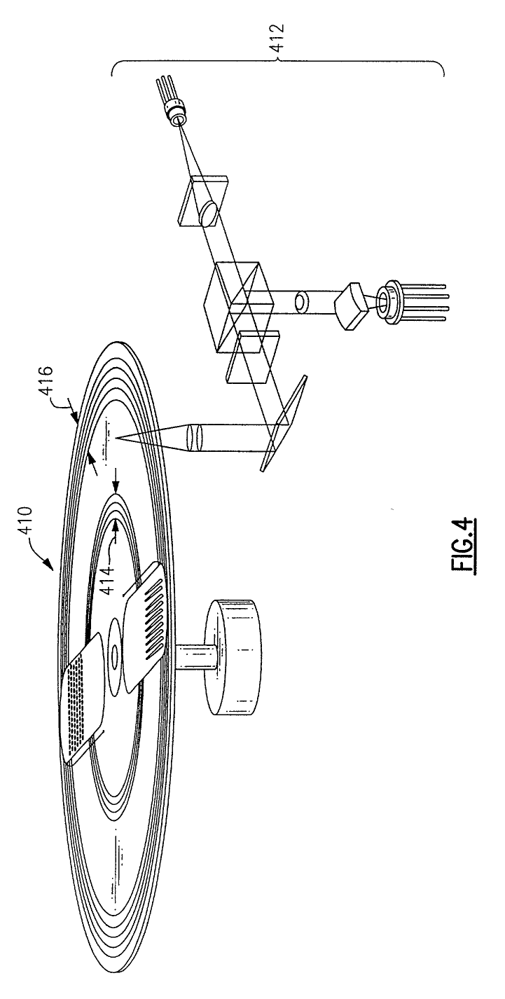

An optical bio-disc such as the disc described above may have one or more microfluidic circuits that perform any of various functions. For example, a microfluidic circuit may be used for separating agglutinants and disperse particles. FIG. 4 illustrates an example of an optical bio-disc 410 of a type having one or more microfluidic circuits as described below, used with an implementation 412 of the optical disc reader system 200 described above. As described in more detail below, the optical disc reader system can determine, by counting tracks of the bio-disc (e.g., tracks 414 or 416 ), the presence or absence of material (e.g., agglutinants or disperse particles) in locations of the microfluidic circuit, and thereby determine the quantity of such material.

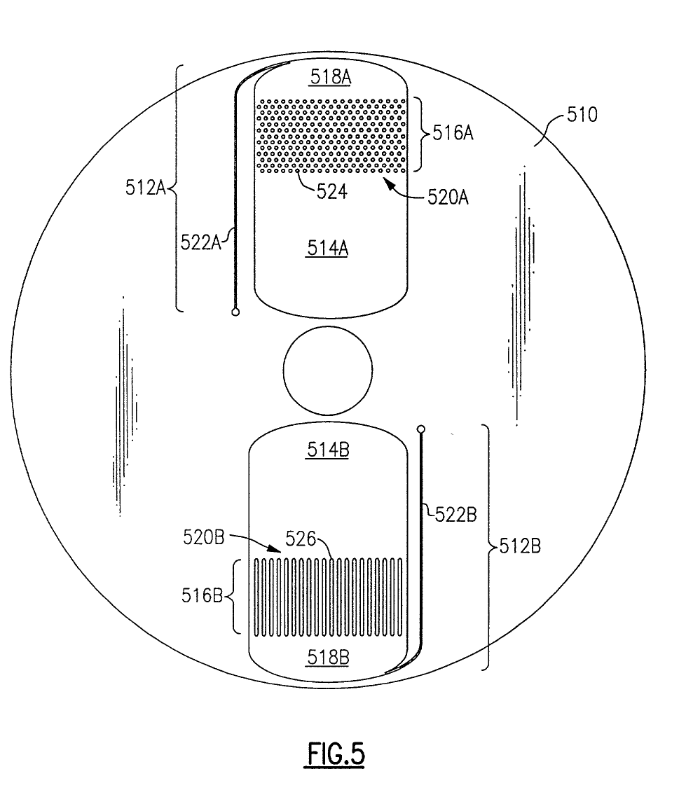

FIG. 5. illustrates an optical bio-disc 510 including two embodiments of microfluidic circuits 512A, 512B for separation and quantitation of agglutinated microparticles or cells. Each microfluidic circuit, when filled with an agglutination assay reaction, separates agglutinants from disperse material. Each circuit is implemented on a rotatable platform whereby centrifugal acceleration provides a force applied to move the particles throughout the circuit.

Each circuit includes several substructures, each of which has at least one role. The circuits have respective agglutinant entry chambers 514A, 514B, each of which is of sufficient size to accommodate the entire sample volume (e.g., approximately 10 microliters). The sample volume may be the result of dilution or other preprocessing, and may be bio-chemical or chemical in nature. After the entire volume of the agglutination reaction is loaded into the entry chamber, the platform is spun for time t₁. Disperse particles (e.g., non-agglutinated particles or particles having less than a particular level of agglutination) or cells pass through a respective separation zone 516A or 516B into a respective collection zone 518A or 518B. Agglutinated cells or particles collect at the respective entry area 520A or 520B of the separation zone and can subsequently be quantitated. In each circuit, a vent port 522A or 522B provides a route for air displacement during filling of the circuit 512A or 512B.

In circuit 512A, the separation zone includes a field of obstructions (e.g., posts such as post 524) having spacing that is smaller than that of the smallest anticipated agglutinant (i.e., the spaces between the posts or obstructions are narrower than the width of the smallest anticipated agglutinant). In circuit 512B, the separation zone includes a field of bars (e.g., ribs such as rib 526) having spacing that is smaller than that of the smallest anticipated agglutinant. The bars may be substantially parallel to each other as shown, or radially orientated, with slits formed therebetween.

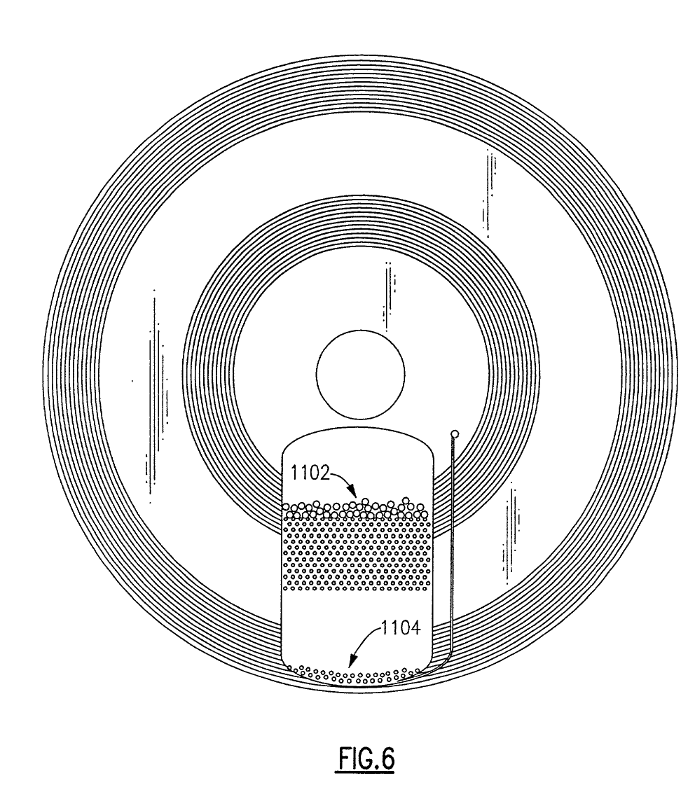

FIG. 6 illustrates an embodiment of the optical bio-disc and microfluidic circuit with agglutinated particles 1102 retained in the entry chamber and disperse particles 1104 which have separated therefrom and moved into the collection zone. The tracks of the optical disc are located as indicated so that the amount of particulate matter may be quantitated as described below. This disc could have tracks throughout, and while shown as concentric circles, they could be a continuous spiral.

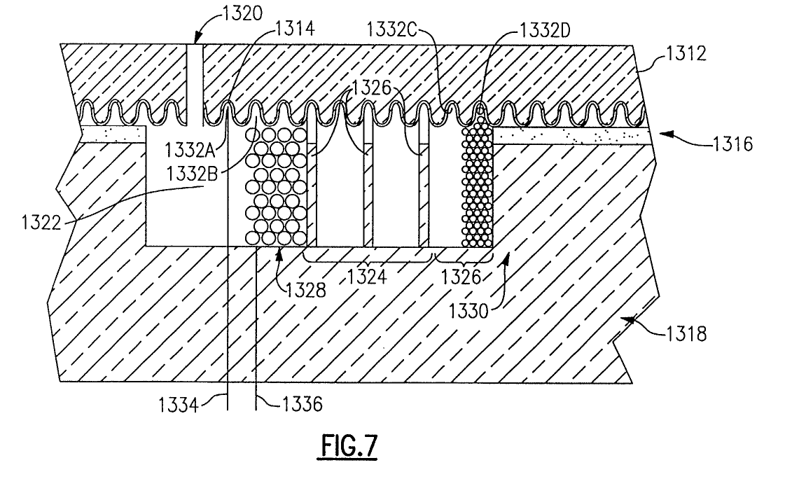

FIG. 7 is a cross sectional side view of an example implementation of microfluidic circuit 512A of the present invention as illustrated by example in conjunction with a reverse wobble optical bio-disc, the view taken along a radius of the disc. The reverse wobble optical bio-disc is more fully disclosed in the following commonly assigned applications, all of which are incorporated herein by reference: published international application WO 00/26677, PCT/US 99/25136, 26 Oct. 1999, entitled TRACKABLE OPTICAL DISCS WITH CONCURRENTLY READABLE ANALYTE MATERIAL; and copending U.S. Provisional Patent Applications OPTICAL DISC ASSEMBLY FOR PERFORMING ASSAYS, filed on May, 29, 2001, Ser. No. 60/294,052; OPTICAL BIO-DISCS FOR PERFORMING MEASUREMENTS OF PHYSICAL SPECIMENS, filed on Jul. 18, 2001, Ser. No. 60/306,226; OPTICAL DISCS AND ASSEMBLIES FOR DETECTION OF MICROSCOPIC STRUCTURES USING

FOCAL ZONE CONTROL, filed on Sep. 19, 2001, Ser. No. 60/323,405. (It is to be noted that circuits of the present invention, such as circuit 512 A, may be implemented on other types of discs.) Top to bottom in FIG. 7, the bio-disc has a polycarbonate cap layer 1312, a metal reflective layer 1314, an adhesive layer 1316, and a polycarbonate substrate layer 1318. Circuit 512A is disposed under the metal reflective layer and extends into the substrate layer. The adhesive layer terminates at the circuit's boundaries.

FIG. 7 illustrates that the bio-disc has an injection or inlet hole 1320 through which material may be injected into the circuit's entry chamber 1322. The circuit has a separation zone 1324 and a collection zone 1326. The separation zone 1324 has posts 1326 that are spaced to cause agglutinated particles 1328 to remain in the entry chamber and to allow disperse particles 1330 to pass from the entry chamber to the collection zone.

The separation zone may have a preselected porosity for passing particles, may have posts or other structures that include glass, glass fiber, plastic fiber, or glass or plastic particles, and may serve as a filter for passing certain particles and preventing certain other particles from passing. The glass fiber may include alumina, silica, or quartz. The plastic fiber may include cellulose acetate, cellulose nitrite, mixed cellulose esters, polyethersulfone polyvinyl chloride, polycrylonitrile, polycarbonate, polysulfone, polyfluorotetra- ethylene, polyvinylidene-fluoride, or cellulose.

Each obstruction or bar may have a predetermined diameter or width. The diameter of consecutive posts may increase as a function of increasing distance from the center of the bio-disc. The number of posts per unit area may increase as a function of increasing distance from the center of the bio-disc.

FIG. 7 illustrates that the bio-disc's tracks 1332A-1332D (appearing in the cross section as pockets in the reflective layer 1314) can be used to help quantitate the agglutinated particles and the disperse particles. For example, an incident light beam that is directed toward the reflective layer along line 1334 reaches track 1332A of, and is reflected by, the reflective layer, but an incident light beam directed along line 1336 is blocked by the agglutinated particles from reaching track 1332B and is therefore not reflected by the reflective layer. As a result, the optical reading system can detect the presence of particles (such as agglutinated or disperse particles) in particular locations (such as in the entry chamber or the collection zone) by detecting whether or not an incident light beam is reflected from corresponding tracks.

In a case in which incident light beam detection is performed on the opposite side of the bio-disc for detection of transmitted instead of reflected incident light, particles can be similarly detected by detecting whether or not an incident light beam is transmitted through corresponding tracks.

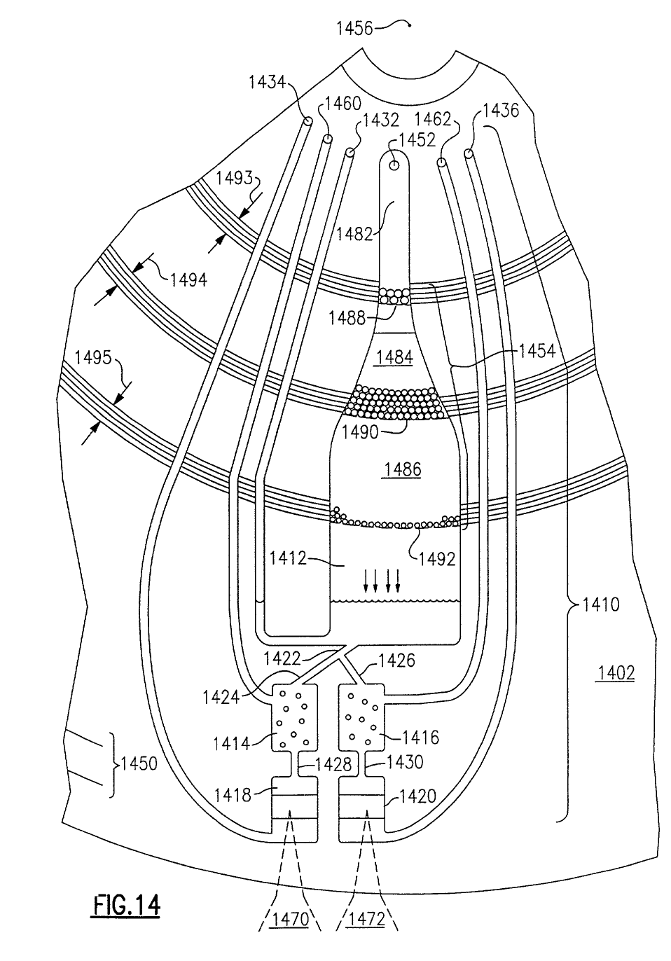

In plan view figures including FIG. 14, tracks are shown in multiple locations where a build up of particles or agglutinants is expected. Although only a limited number of tracks are shown in such figures, it is to be understood that additional tracks or track extensions may be provided that are not shown. In particular, a sufficient number of tracks may be provided to allow the quantitation of any amount of material that can fit in a particular zone, area, or chamber.

Particles or agglutinants may be adequately quantitated even if the particles or agglutinants are not evenly distributed at an end of a zone, area, or chamber. For example, the fact that a track is covered in one part of a chamber and is uncovered in another part of the chamber can be detected by the detector following the path of the track, by determining start and stop points of the material along the track. In at least some cases, the bounds of such material can be determined not only radially but also circumferentially. Alternatively, the amount of material may be estimated by determining an average of the reading from a track's intersection with a zone, area, or chamber, such that, for example, if the average of a reading is 25% of a level indicating a “fully covered” reading, it is determined that material covers, in total, only 25% of a track within a chamber.

The detection of particles preferably occurs at designated target zones. The system knows these zones from a hardware or software trigger as described in conjunction with FIGS. 1A-3. In other areas, the reflective layer may include encoded operational information, such as with pits or dye.

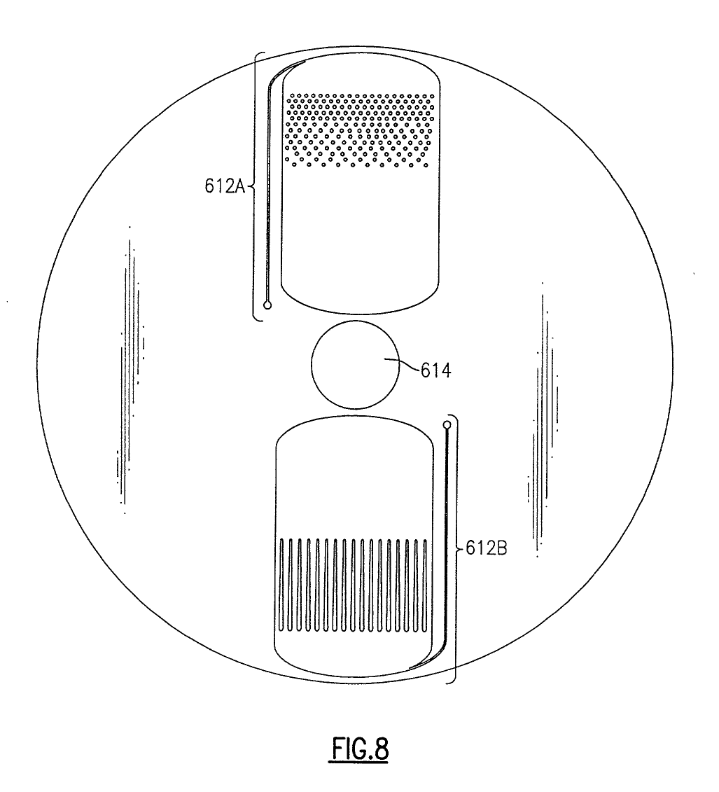

It is possible that clogging of the separation zone may occur in some cases if agglutinated particles form a wall blocking many or all of the spacings through the separation zone. FIGS. 8, 10-13 illustrate alternative embodiments featuring non-uniform spacing among obstructions, which helps to reduce clogging. (Any particular implementation of a bio-disc may have one or more of the circuit embodiments shown in FIGS. 4-13; in at least some cases, it benefits illustrative efficiency to show multiple circuit embodiments together on the same bio-disc.) FIG. 8 illustrates alternative embodiments 612A, 612B of respective circuits 512A, 512B of FIG. 5. In the case of circuit 612A, the density of the posts increases as a function of radial distance from the center 614 of the disc.

In the case of circuit 612 B, the width of the bars becomes narrower as a function of radial distance from the center of the disc to the edge thereof. In a specific example, this is achieved by forming the rib structures with an increasing width as a function of distance from center to edge.

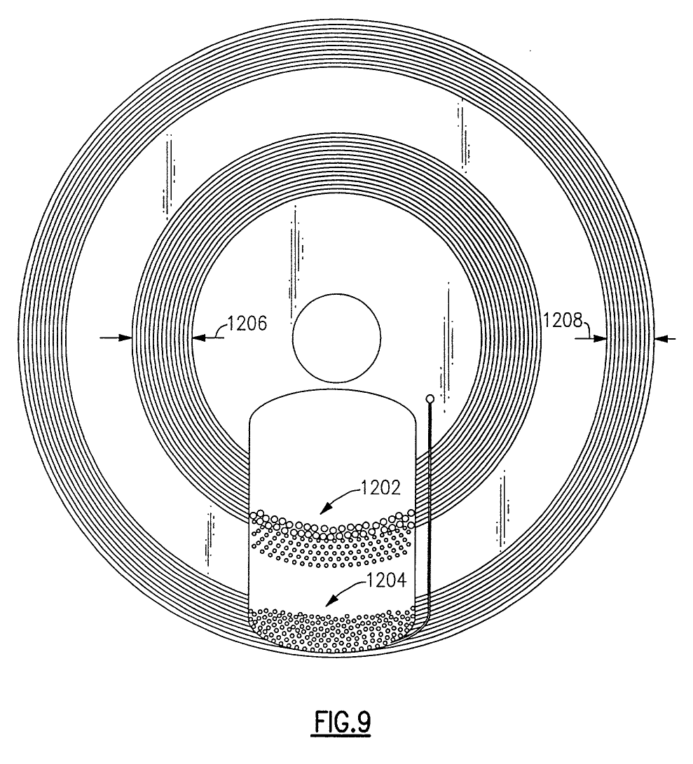

FIG. 9 illustrates microfluidic circuit 612A of FIG. 8 having agglutinated particles 1202 and disperse particles 1204, and inner and outer sets 1206, 1208 of tracks used for quantitating the agglutinant and disperse particles. The field of obstructions in embodiment 612A has obstructions positioned in a substantially constant density and configured of substantially constant shapes. The field is formed in an arc shape, e.g., to substantially conform to the curvature defined by the tracks.

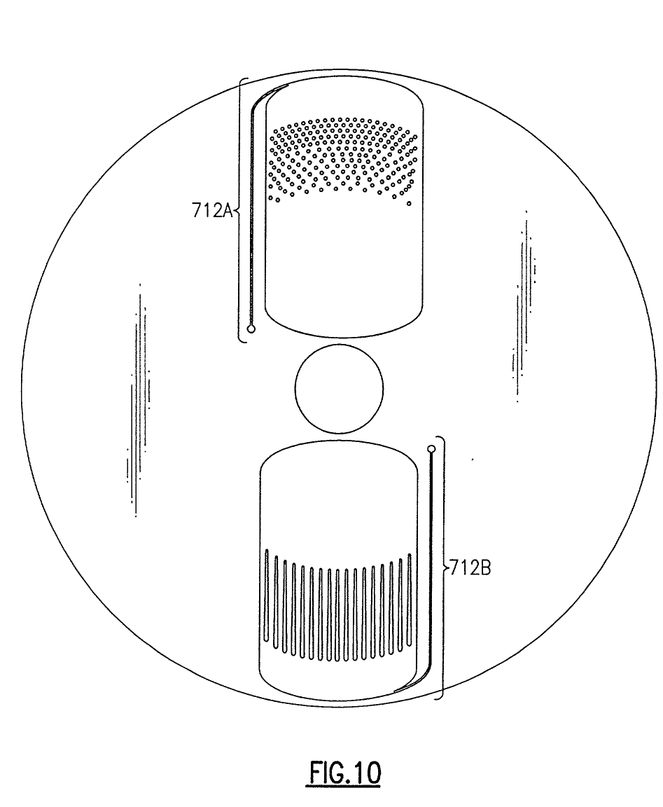

FIG. 10 illustrates other alternative embodiments 712A, 712B of respective circuits 512A, 512B of FIG. 5. The field of posts in embodiment 712A has obstructions positioned in increasing density as distance increases from the center of rotation, and configured of substantially constant shapes. The field is formed in an arc shape, e.g., to substantially conform to the curvature defined by information tracks formed in the disc as shown in FIG. 4.

In embodiment 712B, the front and back edges of the slits and corresponding rib structures are configured in an arc shape, e.g., that substantially conforms to the curvature defined by information tracks formed in the disc.

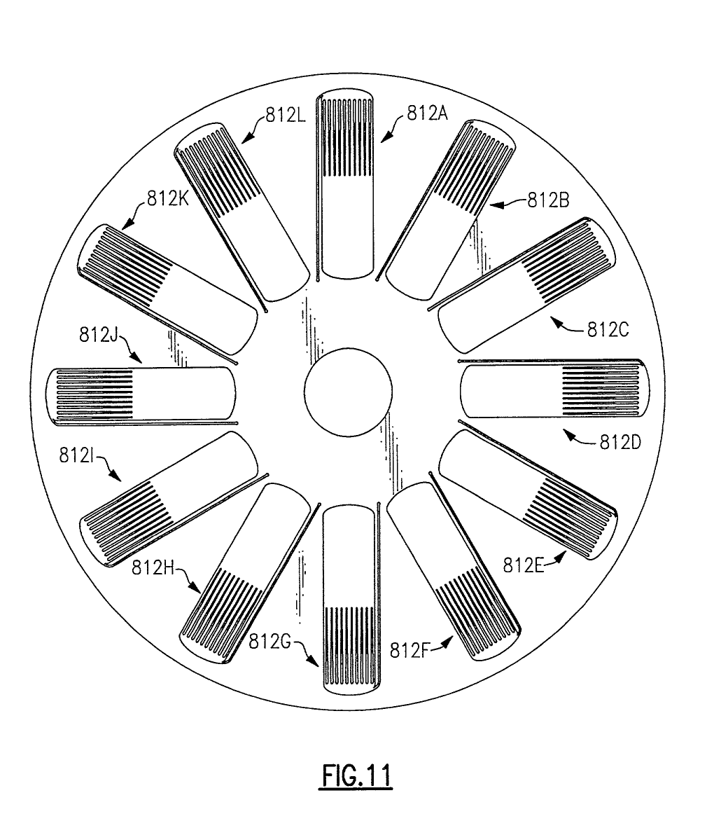

FIG. 11 illustrates an alternate embodiment of the optical bio-disc in which multiple microfluidic circuits 812A-812L are formed on a single disc, which allows multiple identical assays or multiple different assays to be performed on a single disc.

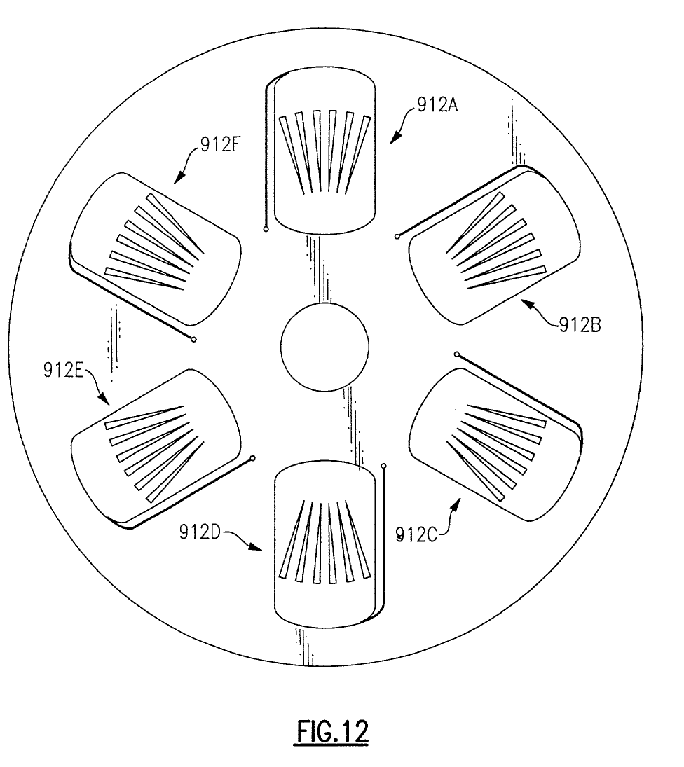

FIG. 12 illustrates multiple microfluidic circuits 912A-912F in which wedge shaped rib structures are radially directed as shown with front and back edges configured in an arc shape, e.g., that substantially conforms to the curvature defined by information tracks formed in the disc (see FIG. 6).

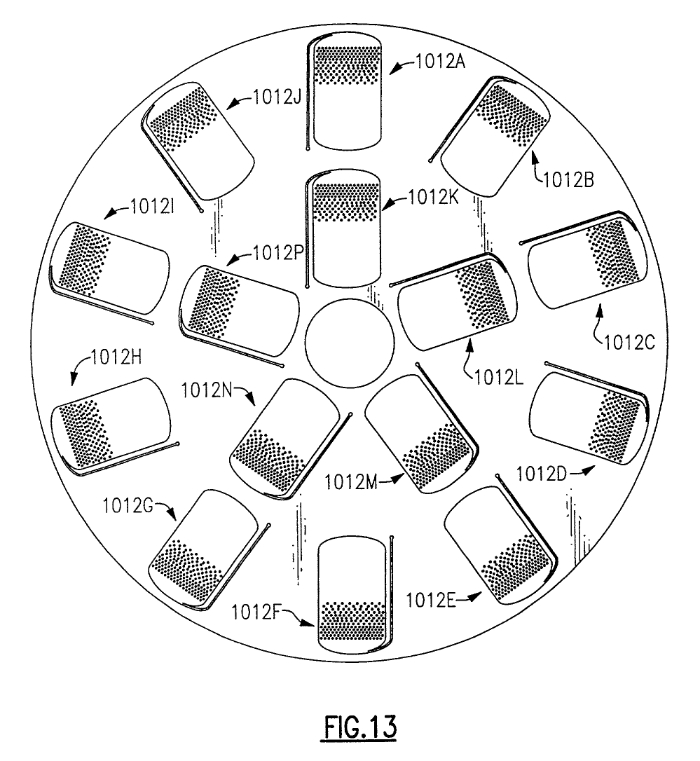

FIG. 13 illustrates an alternate embodiment of the optical bio-disc in which several microfluidic circuits 1012A-1012P are formed in a double concentric ring formation on a single disc.

The following program listing includes PASCAL source code for computer software routines that may be used to help select parameters for specific embodiments of the microfluidic circuits. In particular, the software routines perform particle agglutination modeling in which crosslinks are randomly introduced and the sizes of clumps of agglutinated particles are projected, which facilitates selection of spacing in the separation zone.

program Untitled;
const

beadnum = 10;
links = 30;

type
b = record

color, visited: boolean;
connections: array [1..12] of integer;

links: array [1..beadnum] of integer;
id, connectpoint, linkpoint: integer;
treesize: integer;
end;

var

beads: array [1..beadnum] of b;
ct, tests,k,l,r,p1,p2,bead1,bead2: integer;
test2: boolean;

{
procedure get_bead2;
begin

bead2 := random(beadnum)+1;
tests := 0;
for k := 1 to 12 do

if (beads[bead1].connections[k] = bead2) then

tests := tests + 1;

if (bead 1 = bead2) then

tests := tests + 1;

if (beads[bead1].color = beads[bead2].color) then

tests := tests + 1;

end;
procedure connect;
begin

bead1 := 0;
bead2 := 0;
p1 := 0;
p2 := 0;
bead 1 := random(beadnum)+1;
repeat

get_bead2;
until (tests = 0);
if (beads[bead1].connectpoint < 12) and (beads[bead2].connectpoint < 12)

then

begin

beads[bead1].connectpoint := beads[bead1].connectpoint + 1;
beads[bead2].connectpoint := beads[bead2].connectpoint + 1;
p1 := beads[bead1].connectpoint;
p2 := beads[bead2].connectpoint;
beads[bead1].connections[p1] := bead2;
beads[bead2].connections[p2] := bead1;

end;

end;
}
procedure compare(comp, compto:integer;var count: integer);
var
n: integer;
begin

test2 := false;
count := 0;
n := 0;
for n := 1 to comp do

begin

if (beads[n].linkpoint = compto) then

begin
test2 := true;
count := count + 1;

l:=count;
writeln(test2,‘’,1);

end;

end;
end;
{
procedure countlinks;
begin

for k:= 1 to beadnum do

begin

linkpoint := beads[k].connectpoint;
for 1 := 1 to beads[k].connections[1];

beads[k].links[l] := beads[k].connectpoint do

deepcount;

end;

end;
}
begin

random;
k := 0;

{ for k := 1 to beadnum do

begin

visited := false;
beads[k].id := k;
beads[k].connectpoint := 0;
beads[k].linkpoint := 0;
for 1 := 1 to 12 do

beads[k].connections[1] := 0;

r := random(101);
.if (r>50) then beads[k].color := true

else

beads[k].color := false;

end;

for 1 := 1 to links do

connect;

for k := 1 to beadnum do

begin
writeln(beads[k].id,‘’,beads[k].color,‘’,beads[k].connectpoint,‘

’,beads[k].connections[1],‘’,beads[k].connections[2],‘’,beads[k].connections
[3],‘’,beads[k].connections[4],‘’,beads[k].connections[5]);

readln
end;}

ct:=0;
for k := 1 to beadnum do
begin
beads[k].linkpoint := random(3);
writeln(beads[k].linkpoint);
end;
compare(beadnum,2,ct);
writeln(ct);
end.

In an example procedure for the use of a microfluidic circuit as described above, a reaction occurs between particles in the entry chamber that have biological and other activated surfaces. In response to an assay reagent, which may have particles (e.g., latex- or polystyrene-based particles) with at least one bioactive agent such as an antibody bound thereto, agglutinants may or may not form. As described herein, the microfluidic circuit is structured to cause clumped particles to be separated from unclumped particles, which allows an optical disc having the microfluidic circuit to be used for causing reactions and separating resulting clumped particles from resulting unclumped particles.

The assay reagent or bioactive agent may include freeze-dried material, e.g., material that is freeze-dried into an area of the circuit, such as the entry chamber. The freeze-dried material may dissolve upon interaction with a sample or a specimen. An advantage of using freeze-dried material is that the disc need not be removed from and re-inserted into the reader in an extra step solely for the purpose of introducing the assay reagent or bioactive agent. Another advantage of using freeze-dried material is that, in at least some cases, refrigeration and other preservation techniques and related equipment are unnecessary or less important, which renders at least some implementations of the invention more amenable to use in remote or resource-deprived locations or other places where preservation would otherwise be difficult or impossible.

The term bioactive agent as used herein refers to any molecule A that recognizes a molecule B and binds with specificity thereto. The phrase “binds with specificity” is meant herein to refer to the binding of molecule A to molecule B to a significantly greater extent (e.g., by at least two fold, at least five fold, at least 10 fold, at least one hundred fold, or at least 1000 fold or more) relative to other molecules that may be present in a biological sample. For example, molecules that specifically recognize and bind to other molecules include antibodies, ligands, receptors, enzymes, substrates, biotin, and avidin. The bioactive agent of the invention may be obtained from any source, including viral, bacterial, fungal, plant, animal, in vitro, or synthetically produced materials.

In at least some embodiments, the bioactive agent includes an antibody and the particle has at least one antibody bound thereto. As used herein, the term “antibody” includes polyclonal, monoclonal, and recombinantly created antibodies. Antibodies of the invention can be produced in vivo or in vitro. Methods for the production of antibodies are well known to those skilled in the art. For example, see Antibody Production: Essential Techniques, Peter Delves (Ed.), John Wiley & Son Ltd, ISBN: 0471970107 (1997), which is incorporated herein in its entirely by reference. Alternatively, antibodies may be obtained from commercial sources, e.g., Research Diagnostics Inc., Pleasant Hill Road, Flanders, N.J. 07836.

The selection of a bioactive agent to be bound to a particle is within the skill of those in the art. For example, a receptor-specific ligand may be bound to a particle for the purpose of agglutinating cells expressing the receptor recognized by the ligand or a particle may be bound by a lectin that binds specifically a sugar moiety expressed on the surface of a select population of cells for the purpose of agglutinating those cells. Thus, the techniques and apparatus described herein are easily adapted to many biological assays. The term “antibody” is not meant to be limited to antibodies of any one particular species; for example, antibodies of humans, mice, rats, and goats are all contemplated by the invention. The term “antibody” is also inclusive of any class or subclass of antibodies, as any or all antibody types may be used to bring about an agglutination reaction. For example, the IgG antibody class may be used for agglutination purposes or, if a higher antibody polyvalency is desired, the IgD or IgM class of antibodies may be utilized for the same purpose. Antibody fragments can also be utilized as a bioactive agent of the invention. The use of antibodies in the art of medical diagnostics is well known to those skilled in the art. For example, see Diagnostic and Therapeutic Antibodies (Methods in Molecular Medicine), Andrew J. T. George and Catherine E. Urch (Eds.), Humana Press; ISBN: 0896037983 (2000) and Antibodies in Diagnosis and Therapy: Technologies, Mechanisms and Clinical Data (Studies in Chemistry Series), Siegfried Matzku and Rolf A. Stahel (Eds.), Harwood Academic Pub.; ISBN: 9057023105 (1999), which are incorporated herein in their entirely by reference.

The particle with the bioactive agent bound thereto can be structured in any way suitable for the creation of agglutinants. In at least some embodiments of the invention, one or more bioactive agents can be directly linked to the particle. Thus, particles may be uniformly bound with multiple copies of a single bioactive agent or, alternatively, particles may be bound with multiple copies of two or more bioactive agents to increase the specificity of the binding reaction or the occurrence of the subsequent agglutination reaction. In other embodiments, the bioactive agent can be indirectly linked to the particle. For example, a particle may be coated with a protein such as streptavidin and a bioactive agent such as an antibody can be linked to the streptavidin by way of a biotin moiety attached to the antibody.

With respect to at least some embodiments of the invention, the particle has a first bioactive agent bound thereto and the first bioactive agent binds a second bioactive agent. For example, an anti-lgM IgG antibody can serve as a first bioactive agent bound to a particle, which itself binds an IgM antibody, the second bioactive agent. Thus, the bioactive agent bound to a particle can in at least some embodiments include more than one bioactive agent linked to one another in tandem.

Methods used in accordance with the invention can be qualitative or quantitative. For example, sufficient cross linker or reactant may be present to clump all or nearly all of the particles in the reaction, such that all or nearly all of the particles agglutinate and remain in one area such as the entry chamber. In a converse example, if the concentration of the cross linking agent is zero, all or nearly all of the particles move through the separation zone and into the collection zone. The range of sizes of the agglutinants also depends on the avidity or the activity of the agents on the surface of the particles as well as the initial particle sizes. Thus, in specific implementations pursuant to the invention, the porosity of the separation zone is tuned to the average desired clump size for any given assay or grouped assays.

In a specific example, the dispersed particles are approximately one micron in diameter, and form clumps that may are up to 100 microns (e.g., 25, 50, 75, or 100 microns) in diameter. The following list indicates examples of assays that may be performed using the optical bio-disc:

Serological Assays

Cardiolipin

Rheumatoid Factor

D-Dimer

Platelet Aggregation

C-Reactive Protein

Bacterial Identification (including Bacterial-related Identification)

E. Coli 157

C. Difficile

C. Jejuni

C. Coli

C. Laridis

Meningitis

H. Pylori

C. Neoformans

N. Gonorhoeae

Staphlococcus Aureus

S. Pneumoniae

Streptococcus A

Streptococcus B

Streptococcus C

Streptococcus F

Streptococcus G

Mycoplasma

M. tuberculosis

Viral Identification (including Viral-related Identification)

Meningitis

Rubella

Varicella-Zoster Virus

Mononucleosis (e.g., Epstein Barr)

Cytomegalovirus

Lupus Erythematosus

Human Immunodeficiency Virus (HIV)

Amoebic Identification

Cryptosporidium

Giardia

In use, the optical bio-disc of the invention, once loaded with desired reagents and sample specimens, is inserted into the optical drive. The optical bio-disc may include processing software that directs interaction with the optical drive and related servo controls, digital signal processor (DSP), and central controller of the optical reading system. The centrifugal force resulting from the directed rotation causes disperse particles to be moved toward the perimeter of the disc through the separation zone to the collection zone, with the clumped matter being retained in the entry chamber. In accordance with the software, the optical reading system's read laser is used to quantitate the amount of clumped particulate matter of the disperse particles that moved through the separation zone into the collection zone.

The volume of the clumped material correlates to and is proportional to the amount of chemical or biochemical sample material that is analyzed. For example, in the case of a rheumatoid factor, a high concentration of rheumatoid factor results in a large amount of clumping, whereas a low concentration of rheumatoid factor results in little or no clumping. Thus, the optical bio-disc can be used as a diagnostic tool to help determine the presence of rheumatoid factor in a sample.

In a specific implementation, quantitating the agglutinant or the disperse particles is achieved by counting the number of tracks in the entry chamber or the collection zone, respectively, which are covered by the material being quantitated. A method for determining the volume of agglutinant or disperse particles includes counting the number of tracks related to the known volumetric size of the respective microfluidic chamber.

In a particular example, the optical disc may be used as follows. A biological sample material and an assay reagent that includes particles coated with at least one type of antibody are dispensed into the entry chamber, and are mixed. The biological sample material is allowed to react with the assay reagent to thereby facilitate formation of an agglutinant. The optical disc is rotated so that non-agglutinated particles escape from the entry chamber through the separation zone structure. A quantity of disperse particles or particle agglutinants is determined by counting the number of optical disc tracks in the collection zone or entry chamber, respectively, that are covered by the disperse particles or particle agglutinants, respectively, and performing a volume calculation based on the track count.

In an alternative implementation, the system can be used to provide a simple “yes” or “no” result regarding clumping based on whether a clumping group is detected. In other alternatives, a target zone can be imaged and image recognition software used to detect a desired formation; or transitions between light and dark can be detected and used to sense where clumps of particles are located.

The apparatus described herein may be used in any of multiple applications. For example, FIG. 14 illustrates a bio-disc 1402 having a fluidic circuit 1410 that includes a U shaped main chamber 1412, first and second mixing chambers 1414, 1416, and first and second target areas 1418,1420. First and second legs 1424, 1426 of a conduit 1422 connect main chamber 1412 with first and second mixing chamber 1414, 1416, respectively. Conduits 1428, 1430 connect first and second mixing chambers 1414, 1416 with first and second target areas 1418, 1420, respectively. Chamber 1412 and target areas 1418, 1420 have vents 1432, 1434, 1436, respectively. Bio-disc 1402 may have tracks 1450 bearing software pertaining to analysis or handing techniques or other techniques for use with bio-disc 1402, particularly circuit 1410. The conduits have various different cross sectional sizes corresponding to various different capillary pressures so that the conduits further from the axis of rotation have higher capillary pressure, which causes increased rotation speeds to be required to force material (e.g., fluid) downstream to channels that are more distant from the axis of rotation.

Chamber 1412 may have three separation zones 1482, 1484, 1486 bounded by respective separation structures 1488, 1490, 1492 so that particles or agglutinants of a large size are retained in zone 1482, particles or agglutinants of a medium size pass through separation structure 1488 and are retained in zone 1484, and particles or agglutinants of a small size pass through both separation structures 1490, 1492 and are retained in zone 1486. Sets of tracks 1493, 1494, 1495 may be used to quantitate the amount of material in respective zones 1482, 1484, 1486. The separation structures may be arc shaped to substantially conform to the tracks on the disc. One or more of the separation structures may have openings 3-7 microns wide to allow red blood cells or other like-sized material to pass. The chamber may be shaped and sized to account for the expected proportions of the volumes of sample components to be retained in the zones. For example, in the case of a whole blood sample, it is expected that white blood cell volume will account for 1-2% of the sample volume and that red blood cell volume will account for 50% of the sample volume. Thus, the chamber may be narrower or smaller near center 1456 and accordingly may have a bottle, pyramid, or bell shape such that white blood cells may be retained in a small zone 1482 and red blood cells may be retained in a larger zone such as zone 1484 or 1486. In any case, it is advantageous if the boundaries of the chamber include smooth curves such that it is less likely that the material contained within will become caught in or on a corner or in a crevice.

Bio-disc 1402 may be used in different ways depending on the nature of the expected sample and the characteristic of the sample that may be of interest. In the case of blood, bio-disc 1402 may be used as follows. Blood is inserted into main chamber 1412 via inlet 1452. At one or more speeds of rotation about bio-disc center 1456, centrifugal force urges the blood away from center 1456, such that one or more components of the blood are processed by a processing portion 1454 of main chamber 1412. In a case in which processing portion 1454 includes a filter or other separation means, the blood may be separated by components, such that processed material (e.g., substantially pure blood serum) collects at the bight of chamber 1412.

In particular, different cellular fractions of blood may be quantitated in processing portion 1454. For instance, the hematocrit (hct) is the proportion, by volume, of the blood that consists of red blood cells. The hematocrit is expressed as a percentage, and can be used in a test for anemia. Thus, in an example, an hematocrit of 25% means that there are 25 milliliters of red blood cells in 100 milliliters of blood. If processing portion 1454 is configured so that white blood cells are retained in one or both of zones 1482, 1484 and red blood cells are retained in zone 1486, tracks 1495 can be used to quantitate the red blood cells, e.g., in a determination of the hematocrit. In the case of procedures focusing on white blood cells, which have 7-8 different varieties, different varieties of white blood cells may be tagged with different fluorescent antibodies of different colors. As a result, if white blood cells are separated out and retained in one of the zones 1482, 1484, 1486, the amounts of the different varieties of white blood cells may be quantitated by using one of the sets of tracks 1493, 1494, 1495 based on the color of the fluorescent. In particular, the populations of the different varieties can correlate to different disease processes. In the case of chemotherapy, a count of a variety of white blood cells named neutrophils may be used in the monitoring of a patient's recovery. An antibody having a specific color fluorescent tag that binds to neutrophils may be freeze-dried into the one of the zones 1482, 1484, 1486 that is expected to retain the neutrophils. After the red blood cells and the platelets exit the particular zone in downstream movement, a reader that can detect the specific fluorescent color can be used to quantitate or count the neutrophils that are retained in the zone, by means of the corresponding tracks 1493, 1494, 1495. For instance, a semi-quantitative result could be achieved by detecting an average fluorescent reading for an area, e.g., by detecting an overall amount of fluorescent glow in an area instead of counting fluorescent spots.

In another example pertaining to white blood cells, both neutrophils and basophils may be quantitated, e.g., by using a green fluorescent tag for neutrophils and a red fluorescent tag for basophils. In such a case, a reader that can detect and quantitate two colors could be used to produce a red-to-green ratio that is indicative of the ratio of basophils to neutrophils.

In a particular example, a CD4 to CD8 count is used as a measure of the health of one's immune system, e.g., that may have been affected by Human Immunodeficiency Virus (HIV). Proteins on the surfaces of different varieties of white blood cells serve as part of the function of the immune system and are used as chemical tags to classify cells.

With respect to downstream activity in the circuit, at another, higher speed of rotation, the processed material is directed through legs 1424, 1426 to mixing chambers 1414, 1416, respectively. Mixing chambers 1414, 1416 have inlets 1460, 1462, respectively, through which additive material (e.g., A cells and B cells, respectively) may be added for mixing with the processed material.

In an alternative embodiment that may lack inlets 1460, 1462, the mixing chambers may be pre-loaded with the additive material, e.g., with freeze-dried particles that are dried into the chambers and that dissolve on contact with the processed material. Inlets 1460, 1462 may be needed only in the case of antibodies or reagents or other additive material that is not sufficiently amenable to freeze drying, e.g., A cells and B cells that have a shelf life of approximately one month and cannot be further preserved or subsequently rejuvenated. In at least some cases, cell simulants, which have a substantially longer shelf life, may be used. Such simulants may include polystyrene microparticles having surfaces bearing protein labels that are borne by A cells or B cells or other cells being simulated. An advantage of using freeze-dried material such as the simulant is that the disc need not be removed from and re-inserted into the reader in an extra step solely for the purpose of adding the additive material. In at least some cases, the extra step may be avoided even where freeze-dried material is not used, i.e., the additive material can be inserted at the same time the sample is inserted into inlet 1452, if the capillary paths between inlets 1460, 1462 and respective mixing chambers 1414, 1416 are configured to control the travel time of the additive material from the inlets to the mixing chambers. For example, the capillary paths may be shaped (e.g., in a serpentine arrangement) or sized (e.g., in length or width) to control the travel time. Preventing the additive material from arriving too early or too late to the mixing chambers provides a mixing advantage in that it becomes less likely that the processed material will simply pancake above the additive material or vice versa, which could produce an unsatisfactory mix.

Agitation of the processed material with the additive material may be induced by rotating bio-disc 1402 back and forth at one or more speeds to produce mixtures. After the agitation, an increased speed of rotation, the mixtures are directed by centrifugal force through conduits 1428, 1430 to target areas 1418, 1420. The presence of cells or other results existing in target areas 1418, 1420 may be detected using incident light (e.g., laser) beams 1470, 1472 directed to the target areas, e.g., in accordance with the software of tracks 1450.

In general, one or more of the circuits (or one or more parts thereof) depicted in FIGS. 4-13 may be used in bio-disc 1402 or a bio-disc based on aspects of bio-disc 1402. For example, a structure derived from circuit 512A (FIG. 5) may be used in one or more of the following: processing portion 1454, mixing chambers 1414, 1416, and target areas 1418, 1420, to cause separation of agglutinated particles from disperse particles, such that only agglutinated particles or disperse particles are able to proceed further downstream in circuit 1410. Accordingly, a mass of agglutinated particles or a mass of disperse particles can be directed into a U shaped flow channel for hybridization or antigen antibody linking or another type of chemical reaction, and captured in a target area, and then either imaged or counted, which may aid determination of the precise volume of the agglutinated mass. A mass of agglutinated or dispersed particles may be directed from chamber to chamber by capillary action, by passage through appropriately sized channels, or by providing, in one or more instances, a breakaway seal in a channel or chamber such that rotation at an appropriately high speed causes breakage of the seal to allow the mass to be directed elsewhere for further processing.

A bio-disc 1402 or a bio-disc based on aspects of bio-disc 1402 may be used in the performance or execution of assays and other procedures listed or referenced above, including serological assays, bacterial identification (including bacterial-related identification), viral identification (including viral-related identification), and amoebic identification.

Other embodiments are within the scope of the following claims. For example, the separation zone may include a filter insert that is capable of performing the separation. The disc may use replaceable microfluidic circuits. The disc or microfluidic circuit may include a mechanism for delivering the reagent to the entry chamber automatically, e.g., upon rotation.

what is claimed is:

1. An optical disc for separating disperse particles from particle agglutinants, comprising a separation zone structure having solid components spaced apart to form gaps, the gaps being large enough to allow disperse particles to change position relative to the center of the disc by passing through the separation zone structure, the gaps being too small to allow particle agglutinants to pass through the separation zone structure.

2. The disc of claim 1, further comprising:
a chamber for holding an organic specimen having disperse particles and particle agglutinants, the chamber being in communication with the separation zone structure.

3. The disc of claim 1, further comprising:
an information storage mechanism having result data derived from a test performed on the disc.

4. The disc of claim 1, further comprising:
an information storage mechanism having instruction data directed to a procedure for use with the disc.

5. Rotating apparatus for separating disperse particles from particle agglutinants, comprising a separation zone structure having solid components spaced apart to form gaps, the gaps being large enough to allow disperse particles to change position relative to the center of rotation by passing through the separation zone structure, the gaps being too small to allow particle agglutinants to pass through the separation zone structure.

6. The apparatus of claim 5, further comprising:
a chamber for holding an organic specimen having disperse particles and particle agglutinants, the chamber being in communication with the separation zone structure.

7. The apparatus of claim 5, further comprising:
an information storage mechanism having result data derived from a test performed on the apparatus.

8. The apparatus of claim 5, further comprising:
an information storage mechanism having instruction data directed to a procedure for use with the apparatus.

9. An optical disc, comprising:
a microfluidic circuit that is responsive to centrifugal force resulting from rotation of the disc, the circuit comprising:
an entry chamber for holding a specimen having disperse particles and particle agglutinants; and
a separation zone structure disposed downstream of the entry chamber, the specimen being urged toward the separation zone structure by the centrifugal force, the separation zone structure having gaps, the gaps being large enough to allow disperse particles to escape the entry chamber, the gaps being small enough to retain particle agglutinants in the entry chamber.

10. The optical disc of claim 9, further comprising:
a substrate supporting the microfluidic circuit and having a tracking groove formed therein; and
a reflective layer formed on at least a portion of said substrate so that an incident beam of electromagnetic energy may track along said groove; wherein when the substrate is rotated the presence of particle agglutinant can be determined by the coverage of the tracking groove by agglutinants in the entry chamber after disperse particles escape through the separation zone structure.

11. The optical disc of claim 10, wherein the microfluidic circuit further comprises a collection zone disposed downstream of the separation zone structure, the disperse particles being urged toward the collection zone from the separation zone structure by the centrifugal force.

12. The optical disc of claim 11, wherein when the substrate is rotated the presence of disperse particles can be determined by the coverage of the tracking groove by disperse particles in the collection zone.

13. The optical disc of claim 11, wherein the substrate includes a center and an outer edge, and the collection zone is positioned proximate the outer edge, the entry chamber is positioned proximate the center, and the separation zone structure is positioned therebetween so that when the substrate is rotated, particle agglutinants collect in the entry chamber and the separation zone structure allows disperse particles to pass therethrough and collect in the collection zone.

14. The optical disc of claim 10, wherein the separation zone structure includes a series of posts formed in the substrate, the posts being spaced relative to each other to allow disperse particles to pass through the separation zone structure while retaining particle agglutinants in the collection zone.

15. The optical disc of claim 10, wherein the separation zone structure includes a series of slits formed in the substrate, each slit having a predetermined width that allows disperse particles to pass therethrough while causing particle agglutinants to be retained in the collection zone.

16. The optical disc of claim 15, wherein the slits are formed by a series of rib structures disposed in the separation zone structure.

17. The optical disc of claim 16, wherein the structures forming the series of rib structures are substantially parallel to each another.

18. The optical disc of claim 16, wherein the structures forming the series of rib structures are radially directed from the center of the disc.

19. The optical disc of claim 10, wherein the predetermined width of each slit decreases as a function of increasing distance from the center of the disc.

20. The optical disc of claim 18, wherein each of the rib structures has a width that increases as a function of increasing distance from the center of the disc.

21. The optical disc of claim 14, wherein each post has a predetermined diameter.

22. The optical disc of claim 21, wherein for posts along a radius from the center of the disc along the substrate, the diameter of consecutive posts increases as a function of increasing distance from the center of the disc.

23. The optical disc of claim 14, wherein the number of posts per unit area increases as a function of increasing distance from the center of the disc.

24. The optical disc of claim 15, wherein the width of the slits decreases as a function of increasing distance from the center of the disc.

25. The optical disc of claim 9, wherein the separation zone structure includes a filter having a preselected porosity so that when the optical disc is rotated, disperse particles escape from the entry chamber and particle agglutinants are retained in the entry chamber.

26. The optical disc of claim 25, wherein the filter is formed from a material selected from the group consisting of glass fiber and plastic fiber.

27. The optical disc of claim 26, wherein the glass fiber is formed from a material selected from the group consisting of alumina, silica, and quartz.

28. The optical disc of claim 26, wherein the plastic fiber is formed from a material selected from the group consisting of cellulose acetate, cellulose nitrite, mixed cellulose esters, polyethersulfone polyvinyl chloride, polycrylonitrile, polycarbonate, polysulfone, polyfluorotetra-ethylene, polyvinylidene-fluoride, and cellulose.

29. The optical disc of claim 25, wherein the filter is formed from a material selected from the group consisting of glass particles and plastic particles.

30. The optical disc of claim 29, wherein the glass particles are formed from a material selected from the group consisting of alumina, silica, and quartz.

31. The optical disc of claim 29, wherein the plastic particles are formed from a material selected from the group consisting of cellulose acetate, cellulose nitrite, mixed cellulose esters, polyethersulfone polyvinyl chloride, polycrylonitrile, polycarbonate, polysulfone, polyfluorotetra-ethylene, polyvinylidene-fluoride, and cellulose.

32. A method of using an optical disc comprising a microfluidic circuit that is responsive to centrifugal force resulting from rotation of the disc, the circuit comprising an entry chamber for holding a specimen having disperse particles and particle agglutinants; and a separation zone structure disposed downstream of the entry chamber, the specimen being urged toward the separation zone structure by the centrifugal force, the separation zone structure having gaps, the gaps being large enough to allow disperse particles to escape the entry chamber, the gaps being small enough to retain particle agglutinants in the entry chamber, the method comprising:
dispensing a biological sample material into the entry chamber;
dispensing an assay reagent including particles coated with at least one type of bioactive agent into the entry chamber;
mixing the biological sample material with the assay reagent;
allowing the biological sample material to react with the assay reagent to thereby facilitate formation of an agglutinant; and
rotating the optical disc so that non-agglutinated particles escape from the entry chamber through the separation zone structure.

33. The method of claim 32, wherein the optical disc has optical disc tracks and further comprises a collection zone disposed downstream of the separation zone structure and between the optical disc tracks and a light detector, the method further comprising:
determining a quantity of disperse particles by using the light detector to count the number of optical disc tracks in the collection zone covered by the disperse particles and performing a volume calculation based on the track count.

34. The method of claim 32, wherein the optical disc has optical disc tracks and the entry chamber is disposed between the optical disc tracks and a light detector, the method further comprising:
determining a quantity of particle agglutinants by using the light detector to count the number of optical disc tracks in the entry chamber covered by the particle agglutinants and performing a volume calculation based on the track count.

35. The method of claim 32, wherein the particles coated with the at least one bioactive agent comprises microparticles.

36. The method of claim 32, wherein the particles coated with the at least one bioactive agent comprises latex material.

37. The method of claim 32, further comprising diluting the biological sample material.

38. The method of claim 32, further comprising preprocessing the biological sample material.

39. The method of claim 32, wherein the particles coated with the at least one bioactive agent comprise polystyrene material.

40. The method of claim 32, wherein the at least one bioactive agent has specificity for use in a serological assay.

41. The method of claim 32, wherein the at least one bioactive agent has specificity for use in bacterial identification.

42. The method of claim 32, wherein the at least one bioactive agent has specificity for use in viral identification.

43. The method of claim 32, wherein the at least one bioactive agent has specificity for use in amoebic identification.

44. The disc of claim 1, further comprising:
tracks disposed proximal the separation zone structure, wherein the presence of material on a first side of the separation zone structure may be detected by analyzing a result of directing a light beam toward the tracks.

45. The disc of claim 44, wherein the tracks are disposed such that in operation the entrance to the separation zone structure is interposed between the tracks and a light beam detector.

46. The disc of claim 44, wherein the tracks are disposed such that in operation the tracks are interposed between the entrance to the separation zone structure and a light beam detector.

47. The disc of claim 44, further comprising a collection zone disposed downstream of the separation zone structure, wherein the tracks are disposed such that in operation the collection zone is interposed between the tracks and a light beam detector.

48. The disc of claim 44, further comprising a collection zone disposed downstream of the separation zone structure, wherein the tracks are disposed such that in operation the tracks are interposed between the collection zone and a light beam detector.

49. The method of claim 32, wherein the at least one bioactive agent has specificity for cardiolipin.

50. The method of claim 32, wherein the at least one bioactive agent has specificity for rheumatoid factor.

51. The method of claim 32, wherein the at least one bioactive agent has specificity for d-dimer.

52. The method of claim 32, wherein the at least one bioactive agent has specificity for e. coli 157.

53. The method of claim 32, wherein the at least one bioactive agent has specificity for c. difficile.

54. The method of claim 32, wherein the at least one bioactive agent has specificity for c. jejuni.

55. The method of claim 32, wherein the at least one bioactive agent has specificity for c. coli.

56. The method of claim 32, wherein the at least one bioactive agent has specificity for c. laridis.

57. The method of claim 32, wherein the at least one bioactive agent has specificity for meningitis.

58. The method of claim 32, wherein the at least one bioactive agent has specificity for H. Pylori.

59. The method of claim 32, wherein the at least one bioactive agent has specificity for C. Neoformans.

60. The method of claim 32, wherein the at least one bioactive agent has specificity for N. Gonorhoeae.

61. The method of claim 32, wherein the at least one bioactive agent has specificity for Staphlococcus Aureus.

62. The method of claim 32, wherein the at least one bioactive agent has specificity for S. Pneumoniae.

63. The method of claim 32, wherein the at least one bioactive agent has specificity for Streptococcus A.

64. The method of claim 32, wherein the at least one bioactive agent has specificity for Streptococcus B.

65. The method of claim 32, wherein the at least one bioactive agent has specificity for Streptococcus C.

66. The method of claim 32, wherein the at least one bioactive agent has specificity for Streptococcus F.

67. The method of claim 32, wherein the at least one bioactive agent has specificity for Streptococcus G.

68. The method of claim 32, wherein the at least one bioactive agent has specificity for Mycoplasma.

69. The method of claim 32, wherein the at least one bioactive agent has specificity for Rubella.

70. The method of claim 32, wherein the at least one bioactive agent has specificity for Varicella-Zoster Virus.

71. The method of claim 32, wherein the at least one bioactive agent has specificity for Mononucleosis.

72. The method of claim 32, wherein the at least one bioactive agent has specificity for Cytomegalovirus.

73. The method of claim 32, wherein the at least one bioactive agent has specificity for Lupus Erythematosus.

74. The method of claim 32, wherein the at least one bioactive agent has specificity for Cryptosporidium

75. The method of claim 32, wherein the at least one bioactive agent has specificity for Giardia.

76. The method of claim 32, wherein the at least one bioactive agent has specificity for C-Reactive Protein.

77. An optical disc for separating disperse particles from particle agglutinants, comprising:
a main chamber having a separation zone structure having solid components spaced apart to form gaps, the gaps being large enough to allow disperse particles to change position relative to the center of the disc by passing through the separation zone structure, the gaps being too small to allow particle agglutinants to pass through the separation zone structure;
a mixing chamber in communication with the main chamber; and
a target area in communication with the mixing chamber.

78. An optical disc for separating disperse particles from particle agglutinants, comprising:
a main chamber;
a mixing chamber in communication with the main chamber, the mixing chamber having a separation zone structure having solid components spaced apart to form gaps, the gaps being large enough to allow disperse particles to change position relative to the center of the disc by passing through the separation zone structure, the gaps being too small to allow particle agglutinants to pass through the separation zone structure; and
a target area in communication with the mixing chamber.

79. An optical disc for separating disperse particles from particle agglutinants, comprising:
a main chamber;
a mixing chamber in communication with the main chamber; and
a target area in communication with the mixing chamber, the target area having a separation zone structure having solid components spaced apart to form gaps, the gaps being large enough to allow disperse particles to change position relative to the center of the disc by passing through the separation zone structure, the gaps being too small to allow particle agglutinants to pass through the separation zone structure.

80. A method of using an optical disc comprising a microfluidic circuit that is responsive to centrifugal force resulting from rotation of the disc, the circuit comprising a chamber for holding a specimen, the specimen being urged outward from the center of rotation by the centrifugal force, the disc having tracks disposed in a line intersecting the chamber and a beam detector, the method comprising:
detecting whether a beam intersecting the chamber and a track has been affected by the presence of the specimen in the chamber; and
calculating a volume of the specimen based on the detection.

81. An optical disc for separating disperse particles from particle agglutinants, comprising:
a separation zone structure having solid components spaced apart to form gaps; and
a material holding area in communication with the separation zone structure, the material holding area having freeze-dried bioactive agent material.

82. An optical disc for separating disperse particles from particle agglutinants, comprising:
a main chamber having a separation structure that defines first and second separation zones so that pieces of material having a first size are retained in the first separation zone and other pieces of material having a second size pass through the separation structure to the second separation zone, the size of the first separation zone relative to the size of the second separation zone beng substantially commensurate with the relative proportions of components of an expected sample; and
a track disposed in a line intersecting at least one of the first and second zones and a detector.

83. The optical disc of claim 82, wherein the track is used to quantitate the amount of material in the at least one of the first and second zones.

84. The optical disc of claim 82, wherein the second zone is at least ten times larger than the first zone.

85. The optical disc of claim 82, wherein the boundaries of the chamber include smooth curves.

86. The optical disc of claim 82, wherein the disc is configured to be used to process blood.

87. The optical disc of claim 82, wherein the disc is configured to be used in determining the hematocrit of blood.

88. The optical disc of claim 82, wherein the disc is configured to be used in an analysis of white blood cells.

89. The optical disc of claim 82, wherein the disc includes freeze-dried bioactive agent material.

90. The optical disc of claim 82, wherein the main chamber includes freeze-dried bioactive agent material.
